(19) United States
(12) Patent Application Publication
(10) Pub. No.: US 2026/0200328 A1
(43) Pub. Date: Jul. 16, 2026

(54) VEHICLE SHUT-OFF CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takahiro KURATOMI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/127,867

(22) PCT Filed: Nov. 9, 2022
(86) PCT No.: PCT/JP2022/041690

§ 371 Date: May 7, 2025

(51) Int. Cl. B60L 3/04; B60L 3/00; B60L 58/15

(52) U.S. Cl. CPC B60L 3/04; B60L 58/15; B60L 3/0046; B60L 2240/547

(57) ABSTRACT

A vehicle cut-off control device includes: first cut-off unit that switches to a first cut-off state, wherein a second common path is cut-off, from a first cancel state wherein the first cut-off state is canceled; a second cut-off unit that switches to a second cut-off state, wherein a second branch path is cut-off, from a second cancel state wherein the second cut-off state is canceled; a first detection unit that detects the current value and direction of a current flowing in the second common path; a second detection unit that detects that a current is flowing in the second branch path; and a control unit that switches the first cut-off unit from the first cancel state to the first cut-off state and switches the second cut-off unit from the second cancel state to the second cut-off state, based on signals detected by the first and second detection units.

### CROSS-REFERENCE TO RELATED APPLICATIONS

This application is the U.S. national stage of PCT/JP2022/041690 filed on Nov. 9, 2022, the contents of which is incorporated herein.

### TECHNICAL FIELD

The present disclosure relates to a vehicle cut-off control device.

### BACKGROUND

Energization control systems used in electric vehicles employ mechanisms for cutting off the conductive path between the battery and a load (e.g., inverter, DCDC converter, or charger) when an abnormality occurs, such as when the vehicle is involved in a collision or when a load short-circuit occurs. For example, there is a configuration in which the conductive path is cut-off using a physical cut-off mechanism such as a contactor or a fuse.

In recent years, in order to meet demand for higher battery output and faster charging, the impedance of batteries has been decreasing, and it is thought that the impedance will continue to decrease even further. A decrease in impedance leads to an increase in short-circuit current and an increasing rate of the increase in short-circuit current, thus requiring a larger short-circuit resistance, including for peripheral circuitry, which leads to higher cost in configurations that use a conventional physical cut-off mechanism.

In view of this, consideration has been given to cutting off the conductive path between a battery and a load by electrical insulation using a cut-off device that cuts off the short-circuit current. For example, the vehicle power cut-off system disclosed in JP 2022-13791A has a configuration in which a pyrotechnic circuit breaker is provided in the path between a power storage unit and a load, and the path is cut-off by the pyrotechnic circuit breaker when an abnormality occurs.

In a configuration in which a power storage unit that supplies power to a load receives power from a charging unit, it is conceivable to provide a pyrotechnic circuit breaker such as that described in JP 2022-13791A in a path used in common for both charging and discharging in order to protect the wiring from a charging overcurrent from the charging unit and a discharging overcurrent from the power storage unit. The occurrence of an abnormal state is determined based on the current value of the path used in common for both charging and discharging, and the pyrotechnic circuit breaker is cut-off. In such a configuration, it is difficult to distinguish between a charging overcurrent from the charging unit, a discharging overcurrent that has passed through the charging unit, and a discharging overcurrent that has passed through the load, and the only protection operation that can be performed is to cut off the path that is used in common for both charging and discharging.

The present disclosure has been made based on the above-mentioned circumstances, and an object of the present disclosure is to provide a technology that can detect a charging overcurrent from a charging unit and a discharging overcurrent that has passed through the charging unit with a simple configuration, and efficiently block such overcurrents.

### SUMMARY

A vehicle cut-off control device according to an aspect of the present disclosure is a vehicle cut-off control device to be used in a vehicle power supply system including a power storage unit configured to be charged by a charging unit and a load configured to receive a supply of electric power from the power storage unit, the vehicle power supply system further including a first conductive path provided between a high potential terminal of the power storage unit and a high potential terminal of the load, a second conductive path provided between a low potential terminal of the power storage unit and a low potential terminal of the load, a first branch path branching off from the first conductive path and provided between the first conductive path and a high potential terminal of the charging unit, and a second branch path branching off from the second conductive path and provided between the second conductive path and a low potential terminal of the charging unit, the first conductive path having a first common path provided between the power storage unit and the first branch path, and a third branch path provided between the first branch path and the load, and the second conductive path having a second common path provided between the power storage unit and the second branch path, and a fourth branch path provided between the second branch path and the load, and the vehicle cut-off control device including: a first cut-off unit configured to switch to a first cut-off state, in which at least one of the first common path and the second common path is cut-off, from a first cancel state in which the first cut-off state is canceled; a second cut-off unit configured to switch to a second cut-off state, in which at least one of the first branch path and the second branch path is cut-off, from a second cancel state in which the second cut-off state is canceled; a first detection unit configured to detect a current value of a current flowing in at least one of the first common path and the second common path, and a direction in which the current is flowing; a second detection unit configured to detect that a current is flowing in at least one of the first branch path and the second branch path; and a control unit configured to switch the first cut-off unit from the first cancel state to the first cut-off state and switch the second cut-off unit from the second cancel state to the second cut-off state, based on detection signals detected by the first detection unit and the second detection unit.

### Advantageous Effects

The technology according to the present disclosure makes it possible to detect a charging overcurrent from a charging unit and a discharging overcurrent that has passed through the charging unit with a simple configuration, and efficiently block such overcurrents.

### BRIEF DESCRIPTION OF DRAWINGS

FIG. 1 is a block diagram illustrating a schematic example of a vehicle power supply system that includes a vehicle cut-off control device according to a first embodiment.

FIG. 2 is a flowchart illustrating a flow of control performed by a control unit of the vehicle cut-off control device.

FIG. 3 is a block diagram illustrating a schematic example of a vehicle power supply system that includes a vehicle cut-off control device according to a second embodiment.

FIG. 4 is a block diagram for describing a schematic internal configuration of the control unit in FIG. 3.

FIG. 5 is a flowchart illustrating a flow of control performed by the control unit of the vehicle cut-off control device.

FIG. 6 is a block diagram illustrating a schematic example of a vehicle power supply system that includes a vehicle cut-off control device according to another embodiment.

FIG. 7 is a block diagram illustrating a schematic example of a vehicle power supply system that includes a vehicle cut-off control device according to another embodiment.

FIG. 8 is a block diagram illustrating a schematic example of a vehicle power supply system that includes a vehicle cut-off control device according to another embodiment.

FIG. 9 is a block diagram illustrating a schematic example of a vehicle power supply system that includes a vehicle cut-off control device according to another embodiment.

FIG. 10 is a block diagram illustrating a schematic example of a vehicle power supply system that includes a vehicle cut-off control device according to another embodiment.

### DETAILED DESCRIPTION OF PREFERRED EMBODIMENTS

In a first aspect, a vehicle cut-off control device to be used in a vehicle power supply system including a power storage unit configured to be charged by a charging unit and a load configured to receive a supply of electric power from the power storage unit, the vehicle power supply system further including a first conductive path provided between a high potential terminal of the power storage unit and a high potential terminal of the load, a second conductive path provided between a low potential terminal of the power storage unit and a low potential terminal of the load, a first branch path branching off from the first conductive path and provided between the first conductive path and a high potential terminal of the charging unit, and a second branch path branching off from the second conductive path and provided between the second conductive path and a low potential terminal of the charging unit, the first conductive path having a first common path provided between the power storage unit and the first branch path, and a third branch path provided between the first branch path and the load, and the second conductive path having a second common path provided between the power storage unit and the second branch path, and a fourth branch path provided between the second branch path and the load, and the vehicle cut-off control device including: a first cut-off unit configured to switch to a first cut-off state, in which at least one of the first common path and the second common path is cut-off, from a first cancel state in which the first cut-off state is canceled; a second cut-off unit configured to switch to a second cut-off state, in which at least one of the first branch path and the second branch path is cut-off, from a second cancel state in which the second cut-off state is canceled; a first detection unit configured to detect a current value of a current flowing in at least one of the first common path and the second common path, and a direction in which the current is flowing; a second detection unit configured to detect that a current is flowing in at least one of the first branch path and the second branch path; and a control unit configured to switch the first cut-off unit from the first cancel state to the first cut-off state and switch the second cut-off unit from the second cancel state to the second cut-off state, based on detection signals detected by the first detection unit and the second detection unit.

In the vehicle cut-off control device of the first aspect, when the first detection unit detects that a current having a relatively large current value is flowing in a direction from the high potential terminal of the charging unit toward the low potential terminal, it is possible to detect that a charging overcurrent is flowing from the charging unit. Also, when the first detection unit detects that a current having a relatively large current value is flowing in a direction from the low potential terminal of the charging unit toward the high potential terminal, and furthermore the second detection unit detects that a current is flowing in at least one of the first branch path and the second branch path, it is possible to detect that a discharging overcurrent is flowing in the charging unit. The detection of these overcurrent states can be achieved by a simple configuration in which the first detection unit and the second detection unit are provided. These detected overcurrent states can be efficiently prevented by controlling the first cut-off unit to cut off the connection between the power storage unit and the charging unit and the load, and controlling the second cut-off unit to cut off the connection between the power storage unit and the charging unit.

In a second aspect, the vehicle cut-off control device according to the first aspect may be characterized as follows. With a first direction being a direction of a flow of a charging current from the high potential terminal of the charging unit toward the low potential terminal in at least one of the first common path and the second common path, in a case where the current value detected by the first detection unit is in an increased state and the direction detected by the first detection unit is the first direction, the control unit sets the first cut-off unit to the first cancel state and sets the second cut-off unit to the second cut-off state.

In the vehicle cut-off control device of the second aspect, in the case where the current value detected by the first detection unit is in the increased state and the direction detected by the first detection unit is the first direction (the normal direction of the charging current during charging by the charging unit), it is presumed that a charging overcurrent is flowing from the charging unit. In such a case, by cutting off at least one of the first branch path and the second branch path to prevent a charging overcurrent from flowing from the charging unit side, while also canceling the cutting off of at least one of the first common path and the second common path, it is possible to maintain the supply of electric power from the power storage unit to the load.

In a third aspect, the vehicle cut-off control device according to the first or the second aspect may be characterized as follows. With a second direction being a direction of a flow of a charging current from the low potential terminal of the charging unit toward the high potential terminal in at least one of the first common path and the second common path, in a case where the current value detected by the first detection unit is in an increased state, furthermore the direction detected by the first detection unit is the second direction, and furthermore the second detection unit detected that a current is flowing in at least one of the first branch path and the second branch path, the control unit sets the first cut-off unit to the first cancel state and sets the second cut-off unit to the second cut-off state.

In the vehicle cut-off control device of the third aspect, in the case where the current value detected by the first detection unit is in the increased state, furthermore the direction detected by the first detection unit is the second direction, and furthermore a current is flowing in at least one of the first branch path and the second branch path, it is presumed that a discharging overcurrent that has passed through the charging unit is flowing. In such a case, by cutting off at least one of the first branch path and the second branch path to prevent a discharging overcurrent from flowing from the power storage unit side to the charging unit side, while also canceling the cutting off of at least one of the first common path and the second common path, it is possible to maintain the supply of electric power from the power storage unit to the load.

In a fourth aspect, the vehicle cut-off control device according to any one of the first through the third aspects may be characterized as follows. With a second direction being a direction of a flow of a charging current from the low potential terminal of the charging unit toward the high potential terminal in at least one of the first common path and the second common path, in a case where the current value detected by the first detection unit is in an increased state, furthermore the direction detected by the first detection unit is the second direction, and furthermore the second detection unit detected that a current is not flowing in at least one of the first branch path and the second branch path, the control unit sets the first cut-off unit to the first cut-off state.

In the vehicle cut-off control device of the fourth aspect, in the case where the current value detected by the first detection unit is in the increased state, furthermore the direction detected by the first detection unit is the second direction, and furthermore a current is not flowing in at least one of the first branch path and the second branch path, it is presumed that a discharging overcurrent is flowing from the power storage unit side to the load side. In such a case, by cutting off at least one of the first common path and the second common path, it is possible to prevent a discharging overcurrent from flowing from the power storage unit side to the load side.

In a fifth aspect, the vehicle cut-off control device according to any one of the first through the fourth aspects may be characterized as follows. The first detection unit is provided in one of the first common path and the second common path, and is a current sensor that detects a current value and a direction of a current in the one common path.

In the vehicle cut-off control device of fifth aspect, an overcurrent state in the first common path or the second common path can be detected with a simple configuration in which a current sensor is provided in the first common path or the second common path.

In a sixth aspect, the vehicle cut-off control device according to any one of the first through the fifth aspects may be characterized as follows. The second detection unit is provided in one of the first branch path and the second branch path, or in one of the third branch path and the fourth branch path, and is a current sensor that detects that a current is flowing in at least one of the first branch path and the second branch path based on a current flowing in at least one of the first branch path and the second branch path or in at least one of the third branch path and the fourth branch path.

In the vehicle cut-off control device of the sixth aspect, with a simple configuration in which a current sensor is provided in the first branch path or the second branch path, or in the third branch path or the fourth branch path, it is possible to detect that a current is flowing in at least one of the first branch path and the second branch path.

In a seventh aspect, the vehicle cut-off control device according to any one of the first through the fifth aspects may be characterized as follows. The vehicle cut-off control device further includes: a semiconductor circuit breaker configured to, under control of the control unit, switch between a third cut-off state, in which at least one of the first branch path and the second branch path is cut-off, and a third cancel state in which the third cut-off state is canceled; and a diode connected in parallel with the semiconductor circuit breaker such that an anode is provided on a low potential terminal side of the charging unit and a cathode is provided on a high potential terminal side of the charging unit, wherein the second detection unit detects a voltage of the anode relative to the cathode, and when the semiconductor circuit breaker is set to the third cut-off state, in a case where the voltage detected by the second detection unit is in a first high voltage state, the control unit determines that a current is flowing in at least one of the first branch path and the second branch path.

In the vehicle cut-off control device of the seventh aspect, by setting the semiconductor circuit breaker to the third cut-off state, the control unit can determine whether or not a current is flowing in at least one of the first branch path and the second branch path based on the voltage detected by the second detection unit. Also, by setting the semiconductor circuit breaker to the third cut-off state, at least one of the first branch path and the second branch path can be cut-off quickly.

In an eighth aspect, the vehicle cut-off control device according to any one of the first, the fifth or the seventh aspects may be characterized as follows. The vehicle cut-off control device further includes: a semiconductor circuit breaker configured to, under control of the control unit, switch between a third cut-off state, in which at least one of the first branch path and the second branch path is cut-off, and a third cancel state in which the third cut-off state is canceled; and a diode connected in parallel with the semiconductor circuit breaker such that an anode is provided on a low potential terminal side of the charging unit and a cathode is provided on a high potential terminal side of the charging unit, wherein the second detection unit detects a voltage of the cathode relative to the anode, and when the semiconductor circuit breaker is set to the third cut-off state, in a case where the voltage detected by the second detection unit is in a second high voltage state, the control unit determines that a current is not flowing in at least one of the first branch path and the second branch path, and switches the first cut-off unit from the first cancel state to the first cut-off state.

In the vehicle cut-off control device of the eighth aspects, by setting the semiconductor circuit breaker to the third cut-off state, the control unit can determine whether or not a current is flowing in at least one of the first branch path and the second branch path based on the voltage detected by the second detection unit. If it is determined that a current is not flowing in at least one of the first branch path and the second branch path, it can be inferred that a discharging overcurrent that has passed through the load is flowing. In such a case, by switching the first cut-off unit to the first cut-off state, it is possible to block the flow of the discharging overcurrent that has passed through the load.

### First Embodiment

### Configuration of Vehicle Power Supply System

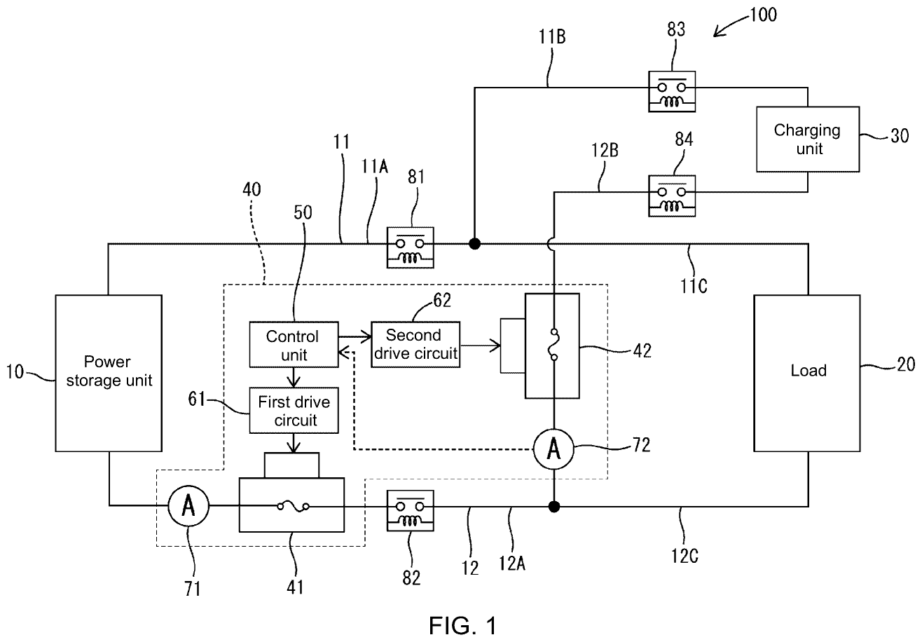

A vehicle power supply system 100 shown in FIG. 1 is a power supply system mounted in a vehicle, and includes a power storage unit 10, a load 20, a charging unit 30, and a vehicle cut-off control device 40. The vehicle power supply system 100 is configured to be capable of supplying electric power from the power storage unit 10 to the load 20, and is also configured to be capable of supplying electric power from the charging unit 30 to the power storage unit 10.

The vehicle power supply system 100 further includes a first conductive path 11, a second conductive path 12, a first branch path 11B, and a second branch path 12B. The first conductive path 11 has a first common path 11A and a third branch path 11C. The second conductive path 12 has a second common path 12A and a fourth branch path 12C.

The first conductive path 11 is provided between the high potential terminal of the power storage unit 10 and the high potential terminal of the load 20. The second conductive path 12 is provided between the low potential terminal of the power storage unit 10 and the low potential terminal of the load 20.

The first common path 11A is provided between the power storage unit 10 and the first branch path 11B. The second common path 12A is provided between the power storage unit 10 and the second branch path 12B.

The first branch path 11B branches off from the first conductive path 11 and is provided between the first conductive path 11 and the high potential terminal of the charging unit 30. The second branch path 12B branches off from the second conductive path 12 and is provided between the second conductive path 12 and the low potential terminal of the charging unit 30.

The third branch path 11C is provided between the first branch path 11B and the load 20. The fourth branch path 12C is provided between the second branch path 12B and the load 20.

A power supply means such as a lead battery, a lithium ion battery, or the like is used as the power storage unit 10. The power storage unit 10 is provided with a high potential terminal and a low potential terminal. The high potential terminal of the power storage unit 10 is electrically connected to one end of the first conductive path 11 (specifically, one end of the first common path 11A). The low potential terminal of the power storage unit 10 is electrically connected to one end of the second conductive path 12 (specifically, one end of the second common path 12A). The power storage unit 10 applies an output voltage that is based on the low potential terminal to the first conductive path 11 (specifically, the first common path 11A).

In the present disclosure, it is desirable that “electrically connected” means a configuration in which connection targets are connected in a mutually conductive state (a state in which a current can flow) such that the potentials of the two targets become equal. However, the present disclosure is not limited to this configuration. For example, “electrically connected” may mean a configuration in which two connection targets are connected in a state in which current can flow between the connection targets via an electric component interposed between them.

The load 20 is, for example, an electrical device mounted in the vehicle. The load 20 is, for example, a motor, a compressor, a PTC thermistor, or the like. The charging unit 30 is configured as a charger that charges the power storage unit 10. The charging unit 30 is configured as, for example, a quick charger (quick charging stand). In the charging unit 30, electric power is supplied to the power storage unit 10 via a charging connector attached to the vehicle, for example.

The vehicle power supply system 100 further includes switches 81, 82, 83, and 84. The switches 81, 82, 83, and 84 are configured as relays, for example. The switches 81 and 82 are provided in the first conductive path 11 and the second conductive path 12, respectively. The switches 83 and 84 are provided in the first branch path 11B and the second branch path 12B, respectively.

The vehicle cut-off control device 40 has a first cut-off unit 41, a second cut-off unit 42, a control unit 50, a first drive circuit 61, a second drive circuit 62, a first detection unit 71, and a second detection unit 72. The first cut-off unit 41 is configured as a pyrotechnic circuit breaker. The first cut-off unit 41 is provided in the second common path 12A. The first cut-off unit 41 is a circuit breaker that physically cuts off the second common path 12A based on a control signal. The first cut-off unit 41 is a PYROFUSE (registered trademark) that cuts off the second common path 12A by rupturing by explosion of an explosive based on a control signal output from the control unit 50 described later. The first cut-off unit 41 switches to a first cut-off state, in which the second common path 12A is cut-off, from a first cancel state in which the first cut-off state is canceled. When the first cut-off unit 41 enters the first cut-off state, an explosion is caused, and the explosion moves a displacement portion so as to physically cut-off the path. One end of the first cut-off unit 41 is electrically connected to the low potential terminal of the power storage unit 10. The other end of the first cut-off unit 41 is electrically connected to one end of the second cut-off unit 42 and the low potential terminal of the load 20.

The second cut-off unit 42 is configured as a pyrotechnic circuit breaker. The second cut-off unit 42 is provided in the second branch path 12B. The second cut-off unit 42 is a circuit breaker that physically cuts off the second branch path 12B based on a control signal. The second cut-off unit 42 is a PYROFUSE (registered trademark) that cuts off the second branch path 12B by rupturing by explosion of an explosive based on a control signal output from the control unit 50 described later. The second cut-off unit 42 switches to a second cut-off state, in which the second branch path 12B is cut-off, from a second cancel state in which the second cut-off state is canceled. When the second cut-off unit 42 enters the second cut-off state, an explosion is caused, and the explosion moves a displacement portion so as to physically cut-off the path. The other end of the second cut-off unit 42 is electrically connected to the low potential terminal of the charging unit 30.

The control unit 50 controls the operation of supplying electric power from the power storage unit 10 to the load 20. The control unit 50 controls the operation of supplying electric power from the charging unit 30 to the power storage unit 10. The control unit 50 is an information processing device that has an information processing function, a calculation function, a control function, and the like. The control unit 50 is mainly constituted by, for example, a microcomputer, and has an arithmetic unit such as a CPU (Central Processing Unit), a memory such as a ROM (Read Only Memory) or a RAM (Random Access Memory), an A/D converter, and the like. The control unit 50 controls the operation of the first cut-off unit 41 and the second cut-off unit 42 based on detection signals detected by the first detection unit 71 and the second detection unit 72, which will be described later.

The control unit 50 controls the cut-off operation of the first cut-off unit 41. The control unit 50 switches the first cut-off unit 41 from the first cancel state to the first cut-off state. The control unit 50 outputs a control signal (first control signal) to cause the first cut-off unit 41 to cut off the second common path 12A. While outputting a second control signal different from the first control signal, the control unit 50 does not cause the first cut-off unit 41 to cut off the second common path 12A. The first control signal is, for example, a high level signal (a signal whose voltage is greater than 0 V). The second control signal is, for example, a low level signal (having a lower voltage than the high level signal, such as 0 V).

The control unit 50 controls the cut-off operation of the second cut-off unit 42. The control unit 50 switches the second cut-off unit 42 from the second cancel state to the second cut-off state. The control unit 50 outputs a control signal (third control signal) to cause the second cut-off unit 42 to cut off the second branch path 12B. While outputting a fourth control signal different from the third control signal, the control unit 50 does not cause the second cut-off unit 42 to cut off the second branch path 12B. The third control signal is, for example, a high level signal (a signal whose voltage is greater than 0 V). The fourth control signal is, for example, a low level signal (having a lower voltage than the high level signal, such as 0 V).

The first drive circuit 61 is electrically connected to the output terminal of the control unit 50 and the first cut-off unit 41. Various circuit configurations using resistors, diodes, bipolar transistors, and the like can be employed for the first drive circuit 61. The first drive circuit 61 receives a control signal from the control unit 50. The first drive circuit 61 is a circuit that can switch from outputting a second voltage signal (e.g., a low level signal) for causing the first cut-off unit 41 to not perform the cut-off operation, to outputting a first voltage signal (e.g., a high level signal) for causing the first cut-off unit 41 to perform the cut-off operation. When the control unit 50 outputs the second control signal while the first cut-off unit 41 is not performing the cut-off operation, the first drive circuit 61 outputs the second voltage signal, and the first cut-off unit 41 is maintained in a state of not performing the cut-off operation. When the control unit 50 outputs the first control signal, the first drive circuit 61 outputs the first voltage signal, and the first cut-off unit 41 performs the cut-off operation.

The second drive circuit 62 is electrically connected to the output terminal of the control unit 50 and the second cut-off unit 42. Various circuit configurations using resistors, diodes, bipolar transistors, and the like can be employed for the second drive circuit 62. The second drive circuit 62 receives a control signal from the control unit 50. The second drive circuit 62 is a circuit that can switch from outputting a fourth voltage signal (e.g., a low level signal) for causing the second cut-off unit 42 to not perform the cut-off operation, to outputting a third voltage signal (e.g., a high level signal) for causing the second cut-off unit 42 to perform the cut-off operation. When the control unit 50 outputs the fourth control signal while the second cut-off unit 42 is not performing the cut-off operation, the second drive circuit 62 outputs the fourth voltage signal, and the second cut-off unit 42 is maintained in a state of not performing the cut-off operation. When the control unit 50 outputs the third control signal, the second drive circuit 62 outputs the third voltage signal, and the second cut-off unit 42 performs the cut-off operation.

The first detection unit 71 is provided in the second common path 12A. The first detection unit 71 detects the current value of the current flowing in the second common path 12A and the direction in which the current is flowing in the second common path 12A. The current value detected by the first detection unit 71 is a value (specifically, an analog voltage value) that enables specifying the current value of the second common path 12A. The first detection unit 71 is configured as, for example, a current sensor (current detection circuit). Specifically, the first detection unit 71 is provided between the power storage unit 10 and the first cut-off unit 41 in the second common path 12A. The current value and the direction of the current detected by the first detection unit 71 are output to the control unit 50.

The second detection unit 72 is provided in the second branch path 12B. The second detection unit 72 detects the current value of the current flowing in the second branch path 12B and the direction in which the current is flowing in the second branch path 12B. The second detection unit 72 detects that a current is flowing in the second branch path 12B based on the current flowing in the second branch path 12B. The current value detected by the second detection unit 72 is a value (specifically, an analog voltage value) that enables specifying the current value of the second branch path 12B. The second detection unit 72 is configured as, for example, a current sensor (current detection circuit). Specifically, the second detection unit 72 is provided between the second cut-off unit 42 and the second conductive path 12 in the second branch path 12B. The current value and the direction of the current detected by the second detection unit 72 are output to the control unit 50.

### Operation of Vehicle Cut-Off Control Device

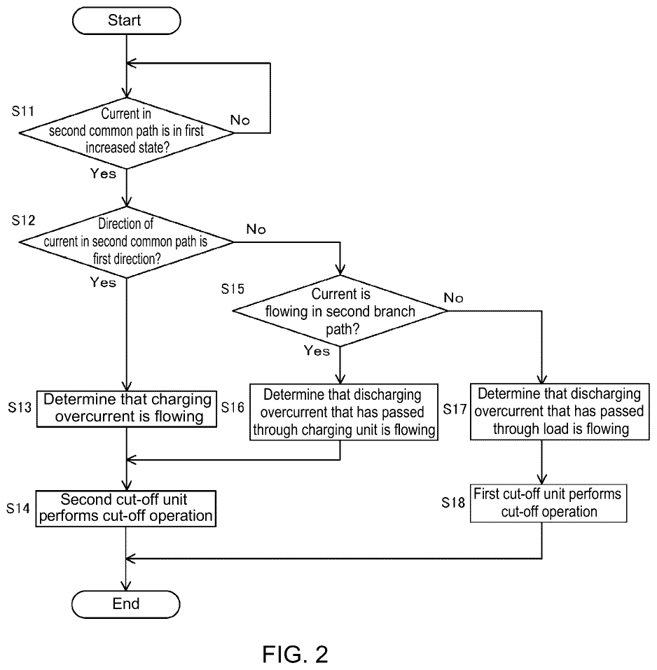

Next, an example of the operation of the vehicle cut-off control device 40 will be described with reference to FIG. 2 and the like. The flowchart shown in FIG. 2 illustrates control that is executed by the control unit 50 when a predetermined start condition is satisfied. The predetermined start condition may be satisfied when, for example, the charging unit 30 is connected to the vehicle equipped with the vehicle power supply system 100 and charging of the power storage unit 10 by the charging unit 30 is started, or may be another condition. A signal indicating that charging of the power storage unit 10 by the charging unit 30 has started is given to the control unit 50 from, for example, an external device (e.g., an external electronic control unit (ECU)).

For example, before the control shown in FIG. 2 is started, the control unit 50 is outputting the second control signal, and the first cut-off unit 41 is being maintained in the first cancel state. Also, the control unit 50 is outputting the fourth control signal, and the second cut-off unit 42 is being maintained in the second cancel state.

First, in step S11, the control unit 50 determines, based on the detection result of the first detection unit 71, whether or not the current value of the current flowing in the second common path 12A is in an increased state. The increased state refers to a state in which the current value of the second common path 12A exceeds a predetermined threshold value, a state in which the speed of increase of the current value of the second common path 12A exceeds a predetermined threshold value, or the like. The control unit 50 repeats the processing of step S11 until it is determined that the current value of the second common path 12A is in the increased state.

In the case of determining in step S11 that the current value of the second common path 12A is in the increased state, the control unit 50 proceeds to “Yes” and determines, based on the detection result of the first detection unit 71, whether or not the direction of the current flowing in the second common path 12A is a first direction (step S12). The first direction is the direction in which charging current flows from the high potential terminal of the charging unit 30 toward the low potential terminal of the charging unit 30 in the second common path 12A. In other words, the first direction is the direction in which the current flowing through the first detection unit 71 flows from the high potential side (the side corresponding to the low potential terminal of the power storage unit 10) to the low potential side (the side corresponding to the low potential terminal of the charging unit 30) during normal charging by the charging unit 30.

In the case of determining in step S12 that the direction of the current flowing in the second common path 12A is the first direction, the control unit 50 moves to “Yes” and determines that a charging overcurrent is flowing from the charging unit 30 (step S13). In other words, the control unit 50 determines that a charging overcurrent is flowing from the charging unit 30 through the first branch path 11B, the first common path 11A, the second common path 12A, and the second branch path 12B. In the case where the current value detected by the first detection unit 71 is in the increased state and the direction of the current detected by the first detection unit 71 is the first direction (the normal direction of the charging current during charging by the charging unit 30), it is presumed that a charging overcurrent is flowing from the charging unit 30.

In the next step S14, the control unit 50 causes the second cut-off unit 42 to perform the cut-off operation. Specifically, the control unit 50 outputs a control signal (the third control signal) to cause the second cut-off unit 42 to cut off the second branch path 12B. In this way, by cutting off the second branch path 12B to prevent a charging overcurrent from flowing from the charging unit 30 side, while also maintaining the second common path 12A in a state of not being cut off, it is possible to maintain the supply of electric power from the power storage unit 10 to the load 20. After step S14, the control unit 50 ends the control of FIG. 2.

On the other hand, in the case of determining in step S12 that the direction of the current flowing in the second common path 12A is not the first direction (it is the second direction), the control unit 50 moves to “No” and determines whether or not a current is flowing in the second branch path 12B based on the detection result of the second detection unit 72 (step S15). For example, if the second detection unit 72 has detected that the current value in the second branch path 12B exceeds a predetermined threshold value, the control unit 50 determines that a current is flowing in the second branch path 12B.

In the case of determining in step S15 that a current is flowing in the second branch path 12B, the control unit 50 determines that a discharging overcurrent is flowing through the charging unit 30 (step S16). In other words, the control unit 50 determines that a discharging overcurrent that has passed through the charging unit 30 is flowing in the second branch path 12B, the second common path 12A, the first common path 11A, and the first branch path 11B. In the case where the current value by the first detection unit 71 is in the increased state, furthermore the direction detected by the first detection unit 71 is the second direction, and furthermore a current is flowing in the second branch path 12B, it is presumed that a discharging overcurrent that has passed through the charging unit 30 is flowing.

In the next step S14, the control unit 50 causes the second cut-off unit 42 to perform the cut-off operation. In this way, by cutting off the second branch path 12B to prevent a discharging overcurrent from flowing from the power storage unit 10 side to the charging unit 30 side, while also maintaining the second common path 12A in a state of not being cut off, it is possible to maintain the supply of electric power from the power storage unit 10 to the load 20.

On the other hand, in the case of determining in step S15 that a current is not flowing in the second branch path 12B (that a current is flowing in the fourth branch path 12C), the control unit 50 determines that a discharging overcurrent that has passed through the load 20 is flowing (step S17). In other words, the control unit 50 determines that a discharging overcurrent that has passed through the load 20 is flowing in the first conductive path 11 and the second conductive path 12. In the case where the current value detected by the first detection unit 71 is in the increased state, furthermore the direction detected by the first detection unit 71 is the second direction, and furthermore a current is not flowing in the second branch path 12B, it is presumed that a discharging overcurrent is flowing from the power storage unit 10 side to the load 20 side.

In the next step S18, the control unit 50 causes the first cut-off unit 41 to perform the cut-off operation. In other words, the control unit 50 outputs a control signal (the first control signal) to cause the first cut-off unit 41 to cut off the second common path 12A. In this manner, by cutting off the second common path 12A, it is possible to prevent a discharging overcurrent from flowing from the power storage unit 10 side to the load 20 side. After step S18, the control unit 50 ends the control of FIG. 2.

### Effects of First Embodiment

The following description relates to an example of effects of the first embodiment.

In the vehicle cut-off control device 40, when the first detection unit 71 detects that a current having a relatively large current value (a current in the increased state) is flowing in a direction from the high potential terminal of the charging unit 30 toward the low potential terminal, it is possible to detect that a charging overcurrent is flowing from the charging unit 30. Also, when the first detection unit 71 detects that a current having a relatively large current value (a current in the increased state) is flowing in a direction from the low potential terminal of the charging unit 30 toward the high potential terminal, and furthermore the second detection unit 72 detects that a current is flowing in the second branch path 12B, it is possible to detect that a discharging overcurrent is flowing through the charging unit 30. The detection of these overcurrent states can be achieved by a simple configuration in which the first detection unit 71 and the second detection unit 72 are provided. These detected overcurrent states can be efficiently prevented by controlling the first cut-off unit 41 to cut off the connection between the power storage unit 10 and the charging unit 30 and load 20, and controlling the second cut-off unit 42 to cut off the connection between the power storage unit 10 and the charging unit 30.

Furthermore, in the vehicle cut-off control device 40, the direction in which the charging current flows from the high potential terminal of the charging unit 30 toward the low potential terminal is defined as the first direction in the second common path 12A. In the case where the current value detected by the first detection unit 71 is in the increased state and the direction of the current flow detected by the first detection unit 71 is the first direction, the control unit 50 sets the first cut-off unit 41 to the first cancel state and sets the second cut-off unit 42 to the second cut-off state. In the case where the current value detected by the first detection unit 71 is in the increased state and the direction of the current detected by the first detection unit 71 is the first direction (the normal direction of the charging current during charging by the charging unit 30), it is presumed that a charging overcurrent is flowing from the charging unit 30. In such a case, by cutting off the second branch path 12B to prevent the flow of a charging overcurrent from the charging unit 30 side, while also canceling the cut-off of the second common path 12A, it is possible to maintain the supply of electric power from the power storage unit 10 to the load 20.

Furthermore, in the vehicle cut-off control device 40, the direction in which the charging current flows from the low potential terminal of the charging unit 30 toward the high potential terminal is defined as the second direction in the second common path 12A. In the case where the current value detected by the first detection unit 71 is in the increased state, furthermore the direction detected by the first detection unit 71 is the second direction, and furthermore the flow of a current in at least either the first branch path 11B or the second branch path 12B is detected by the second detection unit 72, the control unit 50 sets the first cut-off unit 41 to the first cancel state and sets the second cut-off unit 42 to the second cut-off state. In the case where the current value by the first detection unit 71 is in the increased state, furthermore the direction detected by the first detection unit 71 is the second direction, and furthermore current is flowing in the second branch path 12B, it is presumed that a discharging overcurrent that has passed through the charging unit 30 is flowing. In such a case, by cutting off the second branch path 12B to prevent a discharging overcurrent from flowing from the power storage unit 10 side to the charging unit 30 side, while also cutting off the second common path 12A, it is possible to maintain the supply of electric power from the power storage unit 10 to the load 20.

Furthermore, in the vehicle cut-off control device 40, the direction in which the charging current flows from the low potential terminal of the charging unit 30 toward the high potential terminal is defined as the second direction in the second common path 12A. In the case where the current value detected by the first detection unit 71 is in the increased state, furthermore the direction detected by the first detection unit 71 is the second direction, and furthermore it is detected by the second detection unit 72 that a current is not flowing in the second branch path 12B, the control unit 50 sets the first cut-off unit 41 to the first cut-off state. In the vehicle cut-off control device 40, in the case where the current value detected by the first detection unit 71 is in the increased state, furthermore the direction detected by the first detection unit 71 is the second direction, and furthermore a current is not flowing in the second branch path 12B, it is presumed that a discharging overcurrent is flowing from the power storage unit 10 side to the load 20 side. In such a case, by cutting off the second common path 12A, it is possible to prevent a discharging overcurrent from flowing from the power storage unit 10 side to the load 20 side.

Furthermore, in the vehicle cut-off control device 40, the first detection unit 71 is provided on one side of the second common path 12A, and is a current sensor that detects the current value and the direction of the current flowing in the second common path 12A. This makes it possible to detect an overcurrent state in the second common path 12A with a simple configuration in which a current sensor is provided in the second common path 12A.

Furthermore, in the vehicle cut-off control device 40, the second detection unit 72 is provided in the second branch path 12B, and is a current sensor that detects that a current is flowing in the second branch path 12B based on the current flowing in the second branch path 12B. This makes it possible to detect the flow of current through the second branch path 12B with a simple configuration in which a current sensor is provided in the second branch path 12B.

### Second Embodiment

A vehicle power supply system 200 of the second embodiment differs from the first embodiment mainly in that a first semiconductor circuit breaker 243 and a second semiconductor circuit breaker 244 are provided, but other aspects are the same. Note that components the same as those in the first embodiment are denoted by the same reference numerals, and detailed descriptions thereof will be omitted.

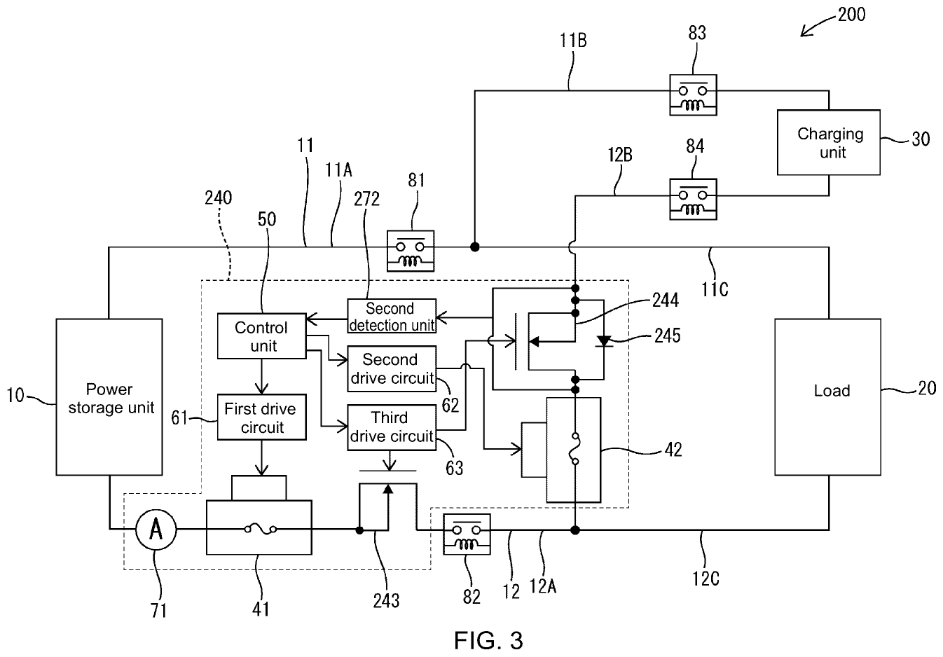

As shown in FIG. 3, the vehicle power supply system 200 includes a power storage unit 10, a load 20, a charging unit 30, and a vehicle cut-off control device 240. The vehicle cut-off control device 240 has a first cut-off unit 41, a second cut-off unit 42, a first semiconductor circuit breaker 243, a second semiconductor circuit breaker 244, a diode 245, a control unit 50, a first drive circuit 61, a second drive circuit 62, a third drive circuit 63, a first detection unit 71, and a second detection unit 272.

The first semiconductor circuit breaker 243 is provided in the second common path 12A. The first semiconductor circuit breaker 243 is configured as a semiconductor switch that turns on and off. The first semiconductor circuit breaker 243 is, for example, an n-channel metal-oxide-semiconductor field effect transistor (MOSFET). The gate of the first semiconductor circuit breaker 243 is electrically connected to the third drive circuit 63, which will be described later. The source of the first semiconductor circuit breaker 243 is electrically connected to the first cut-off unit 41. The drain of the first semiconductor circuit breaker 243 is electrically connected to the second cut-off unit 42 and the load 20.

Based on a control signal output from the control unit 50, the first semiconductor circuit breaker 243 switches to a cut-off state (off state), in which the second common path 12A is cut-off, from a cancel state (on state) in which the cut-off state of the second common path 12A is canceled. Specifically, when a fifth voltage signal from the later-described third drive circuit 63 is input to the gate based on a fifth control signal from the control unit 50, the state is switched from the cancel state to the cut-off state. The first semiconductor circuit breaker 243 switches from the cut-off state to the cancel state based on a control signal (sixth control signal) output from the control unit 50. Specifically, when a sixth voltage signal from the third drive circuit 63 is input to the gate based on the sixth control signal from the control unit 50, the state is switched from the cut-off state to the cancel state.

The second semiconductor circuit breaker 244 is provided in the second branch path 12B. The second semiconductor circuit breaker 244 has a configuration similar to that of the first semiconductor circuit breaker 243. The gate of the second semiconductor circuit breaker 244 is electrically connected to the later-described third drive circuit 63. The source of the second semiconductor circuit breaker 244 is electrically connected to the low potential terminal of the charging unit 30. The drain of the second semiconductor circuit breaker 244 is electrically connected to the second cut-off unit 42.

Based on a control signal output from the control unit 50, the second semiconductor circuit breaker 244 switches to a cut-off state (third cut-off state, off state), in which the second branch path 12B is cut-off, from a cancel state (third cancel state, on state) in which the cut-off state of the second branch path 12B is canceled. Specifically, when a seventh voltage signal from the later-described third drive circuit 63 is input to the gate based on a seventh control signal from the control unit 50, the state is switched from the cancel state to the cut-off state. The second semiconductor circuit breaker 244 switches from the cut-off state to the cancel state based on a control signal (eighth control signal) output from the control unit 50. Specifically, when an eighth voltage signal from the third drive circuit 63 is input to the gate based on the eighth control signal from the control unit 50, the state is switched from the cut-off state to the cancel state.

The diode 245 is connected in parallel with the second semiconductor circuit breaker 244 in the second branch path 12B. The diode 245 is configured as a parasitic diode of the second semiconductor circuit breaker 244, for example. The anode of the diode 245 is electrically connected to the source of the second semiconductor circuit breaker 244, on the low potential terminal side of the charging unit 30. The cathode of the diode 245 is electrically connected to the drain of the second semiconductor circuit breaker 244, on the high potential terminal side of the charging unit 30.

The third drive circuit 63 is electrically connected to the output terminal of the control unit 50, the gate of the first semiconductor circuit breaker 243, and the gate of the second semiconductor circuit breaker 244. The third drive circuit 63 is, for example, a gate driver circuit, and can employ various circuit configurations using resistors, diodes, bipolar transistors, and the like. The third drive circuit 63 receives a control signal from the control unit 50. The third drive circuit 63 is a circuit that can switch between outputting the fifth voltage signal (e.g., a low level signal) for setting the first semiconductor circuit breaker 243 to the off state, and outputting the sixth voltage signal (e.g., a high level signal) for setting the first semiconductor circuit breaker 243 to the on state. While the control unit 50 outputs the fifth control signal, the third drive circuit 63 outputs the fifth voltage signal, and the first semiconductor circuit breaker 243 is maintained in the off state. When the output of the control unit 50 switches from the sixth control signal to the fifth control signal, the fifth voltage signal is output from the third drive circuit 63, and the first semiconductor circuit breaker 243 switches from the on state to the off state. While the control unit 50 outputs the sixth control signal, the third drive circuit 63 outputs the sixth voltage signal, and the first semiconductor circuit breaker 243 is maintained in the on state. The sixth control signal (e.g., a high level signal) is a voltage signal whose magnitude exceeds the gate threshold voltage of the first semiconductor circuit breaker 243.

Also, the third drive circuit 63 is a circuit that can switch between outputting the seventh voltage signal (e.g., a low level signal) for setting the second semiconductor circuit breaker 244 to the off state, and outputting the eighth voltage signal (e.g., a high level signal) for setting the second semiconductor circuit breaker 244 to the on state. While the control unit 50 outputs the seventh control signal, the third drive circuit 63 outputs the seventh voltage signal, and the second semiconductor circuit breaker 244 is maintained in the off state. When the output of the control unit 50 switches from the eighth control signal to the seventh control signal, the seventh voltage signal is output from the third drive circuit 63, and the second semiconductor circuit breaker 244 switches from the on state to the off state. While the control unit 50 outputs the eighth control signal, the third drive circuit 63 outputs the eighth voltage signal, and the first semiconductor circuit breaker 243 is maintained in the on state. The eighth control signal (e.g., a high level signal) is a voltage signal whose magnitude exceeds the gate threshold voltage of the first semiconductor circuit breaker 243.

The second detection unit 272 detects the voltage across the second semiconductor circuit breaker 244 (the source-drain voltage). The second detection unit 272 is a circuit that outputs an analog voltage value that enables specifying the value of the voltage across the second semiconductor circuit breaker 244. The second detection unit 272 may be, for example, a voltage divider circuit, and a value obtained by dividing the value of the voltage across the second semiconductor circuit breaker 244 by the voltage divider circuit may be input to the control unit 50 as a detection value. Specifically, the second detection unit 272 can detect the value of the voltage of the anode of the diode 245 relative to the cathode, and the value of the voltage of the cathode of the diode 245 relative to the anode.

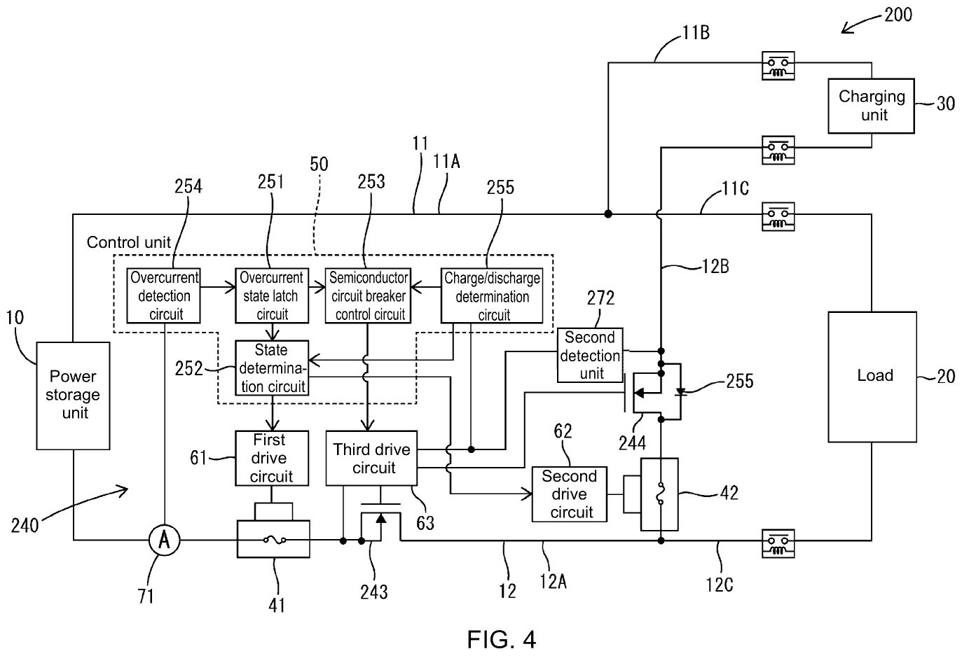

FIG. 4 is a block diagram illustrating the schematic internal configuration of the control unit 50 of FIG. 3. As shown in FIG. 4, the control unit 50 has an overcurrent state latch circuit 251, a state determination circuit 252, a semiconductor circuit breaker control circuit 253, an overcurrent detection circuit 254, and a charge/discharge determination circuit 255. The overcurrent detection circuit 254 outputs a signal to the overcurrent state latch circuit 251 based on the increased state of the current in the second common path 12A detected by the first detection unit 71. The overcurrent state latch circuit 251 holds information indicating the overcurrent state, based on the signal output from the overcurrent detection circuit 254. The overcurrent state latch circuit 251 outputs information indicating the overcurrent state to the semiconductor circuit breaker control circuit 253 and the state determination circuit 252.

The semiconductor circuit breaker control circuit 253 transmits a control signal to the third drive circuit 63. The charge/discharge determination circuit 255 detects the voltage across the second semiconductor circuit breaker 244 (the source-drain voltage) and determines whether or not a current is flowing in the second branch path 12B. The charge/discharge determination circuit 255 outputs information indicating whether or not a current is flowing in the second branch path 12B, to the semiconductor circuit breaker control circuit 253 and the state determination circuit 252.

The state determination circuit 252 determines whether or not a discharging overcurrent that has passed through the charging unit 30 is flowing or a discharging overcurrent that has passed through the load 20 is flowing, based on the output signal from the overcurrent state latch circuit 251 and the output signal from the charge/discharge determination circuit 255. The state determination circuit 252 outputs a voltage signal (the first voltage signal if the first cut-off unit 41 is to perform the cut-off operation) to the first drive circuit 61. The state determination circuit 252 outputs a voltage signal (the third voltage signal if the second cut-off unit 42 is to perform the cut-off operation) to the second drive circuit 62.

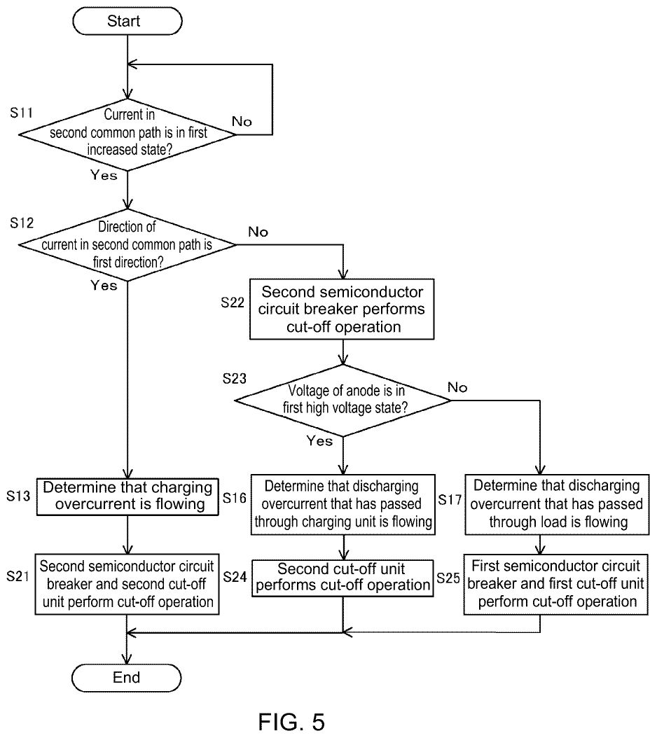

Operation of Vehicle Cut-off Control DeviceNext, an example of operations of the vehicle cut-off control device 240 will be described with reference to FIG. 5 and the like. The flowchart shown in FIG. 5 illustrates control that is executed by the control unit 50 when a predetermined start condition is satisfied. The predetermined start condition is satisfied similarly to the first embodiment.

For example, before the control shown in FIG. 5 is started, the control unit 50 is outputting the second control signal, and the first cut-off unit 41 is being maintained in the first cancel state. The control unit 50 is outputting the fourth control signal, and the second cut-off unit 42 is being maintained in the second cancel state. The control unit 50 is outputting the sixth voltage signal, and the first semiconductor circuit breaker 243 is being maintained in the cancel state. The control unit 50 is outputting the eighth voltage signal, and the second semiconductor circuit breaker 244 is being maintained in the cancel state.

The control unit 50 performs steps S11 to S13 similarly to as in the first embodiment. In the next step S21, the control unit 50 sets the second semiconductor circuit breaker 244 to the cut-off state and causes the second cut-off unit 42 to perform the cut-off operation. Similarly, the control unit 50 outputs control signals (the seventh control signal and the third control signal) to cause the second semiconductor circuit breaker 244 and the second cut-off unit 42 to cut off the second branch path 12B. In this way, by cutting off the second branch path 12B to prevent a charging overcurrent from flowing from the charging unit 30 side, while also maintaining the second common path 12A in a state of not being cut off, it is possible to maintain the supply of electric power from the power storage unit 10 to the load 20. Here, the control unit 50 performs control such that the second cut-off unit 42 performs the cut-off operation after the second semiconductor circuit breaker 244 is switched to the cut-off state. Accordingly, the second semiconductor circuit breaker 244 can quickly cut-off the second common path 12A, and it is possible to improve the insulation performance in the cut-off of the second common path 12A by the second cut-off unit 42. After step S21, the control unit 50 ends the control of FIG. 5.

On the other hand, in the case of determining in step S12 that the direction of the current flowing in the second common path 12A is not the first direction (it is the second direction), the control unit 50 moves to “No” and sets the second semiconductor circuit breaker 244 to the cut-off state (step S22). Specifically, the control unit 50 outputs the fifth control signal to cause the second semiconductor circuit breaker 244 to cut off the second branch path 12B.

In the next step S23, the control unit 50 determines whether or not the voltage detected by the second detection unit 272 (the voltage of the anode relative to the cathode of the diode 245) is in a first high voltage state. The first high voltage state is, for example, a state in which the voltage of the anode relative to the cathode of the diode 245 exceeds a predetermined threshold voltage. The predetermined threshold voltage is, for example, a value slightly smaller than the Vf (forward voltage) of the diode 245. When a discharge current that has passed through the charging unit 30 flows through the second common path 12A, the voltage of the anode relative to the cathode of the diode 245 increases by an amount corresponding to Vf (forward voltage).

In the case of determining in step S23 that the voltage of the anode relative to the cathode of the diode 245 is in the first high voltage state, the control unit 50 moves to “Yes” and determines that a discharging overcurrent that has passed through the charging unit 30 is flowing (step S16). In this way, when the second semiconductor circuit breaker 244 is switched to the cut-off state, if the voltage detected by the second detection unit 272 (the voltage of the anode relative to the cathode of the diode 245) is in the first high voltage state, the control unit 50 determines that a current is flowing in the second branch path 12B.

In the next step S24, the control unit 50 causes the second cut-off unit 42 to perform the cut-off operation. Specifically, the control unit 50 outputs the third control signal to cause the second cut-off unit 42 to cut off the second branch path 12B. In this way, by cutting off the second branch path 12B to prevent a charging overcurrent from flowing from the charging unit 30 side, while also maintaining the second common path 12A in a state of not being cut off, it is possible to maintain the supply of electric power from the power storage unit 10 to the load 20. Here, the control unit 50 performs control such that the second cut-off unit 42 performs the cut-off operation after the second semiconductor circuit breaker 244 is switched to the cut-off state. Accordingly, the second semiconductor circuit breaker 244 can quickly cut-off the second branch path 12B, and it is possible to improve the insulation performance in the cut-off of the second branch path 12B by the second cut-off unit 42. After step S24, the control unit 50 ends the control of FIG. 5.

On the other hand, in the case of determining in step S23 that the voltage of the anode relative to the cathode of diode 245 is not in the first high voltage state (it is in a second high voltage state), the control unit 50 moves to “No” and determines that a discharging overcurrent that has passed through the load 20 is flowing (step S17). The second high voltage state is, for example, a state in which the voltage of the cathode relative to the anode of the diode 245 exceeds a predetermined second threshold voltage. The predetermined second threshold voltage is, for example, a value slightly smaller than the output voltage of the charging unit 30. When a discharge current that has passed through the charging unit 30 is not flowing in the second common path 12A, the voltage of the cathode relative to the anode of the diode 245 increases by an amount corresponding to the output voltage of the charging unit 30.

In the next step S25, the control unit 50 sets the first semiconductor circuit breaker 243 to the cut-off state and causes the first cut-off unit 41 to perform the cut-off operation. Specifically, the control unit 50 outputs control signals (the fifth control signal and the first control signal) to cause the first semiconductor circuit breaker 243 and the first cut-off unit 41 to cut off the second common path 12A. In this manner, by switching the first cut-off unit 41 to the first cut-off state, it is possible to block the flow of a discharging overcurrent that has passed through the load 20. Here, the control unit 50 performs control such that the first cut-off unit 41 performs the cut-off operation after the first semiconductor circuit breaker 243 switches to the cut-off state. Accordingly, the first semiconductor circuit breaker 243 can quickly cut-off the second common path 12A, and it is possible to improve the insulation performance in the cut-off of the second common path 12A by the first cut-off unit 41. After step S25, the control unit 50 ends the control of FIG. 5.

### Effects of Second Embodiment

The following description relates to an example of effects of the second embodiment.

The vehicle cut-off control device 240 includes the second semiconductor circuit breaker 244 that, under control of the control unit 50, switches between the third cut-off state in which the second branch path 12B is cut-off and the third cancel state in which the third cut-off state is canceled, and the diode 245 connected in parallel with the second semiconductor circuit breaker 244 such that the anode is provided on the low potential terminal side of the charging unit 30 and the cathode is provided on the high potential terminal side of the charging unit 30. The second detection unit 72 detects the voltage of the anode relative to the cathode. When the second semiconductor circuit breaker 244 is switched to the third cut-off state, if the voltage detected by the second detection unit 72 is in the first high voltage state, the control unit 50 determines that a current is flowing in the second branch path 12B. In this way, in the vehicle cut-off control device 240, by setting the second semiconductor circuit breaker 244 to the third cut-off state, the control unit 50 can determine whether or not a current is flowing in the second branch path 12B based on the voltage detected by the second detection unit 72. Moreover, by setting the second semiconductor circuit breaker 244 to the third cut-off state, the second branch path 12B can be cut-off quickly.

Furthermore, in the vehicle cut-off control device 240, the second detection unit 72 detects the voltage of the cathode relative to the anode. When the second semiconductor circuit breaker 244 is switched to the third cut-off state, if the voltage detected by the second detection unit 72 is in the second high voltage state, the control unit 50 determines that a current is not flowing in the second branch path 12B and switches the first cut-off unit 41 from the first cancel state to the first cut-off state. As a result, by setting the second semiconductor circuit breaker 244 to the third cut-off state, the control unit 50 can determine whether or not a current is flowing in the second branch path 12B based on the voltage detected by the second detection unit 72. If it is determined that a current is not flowing in the second branch path 12B, it can be inferred that a discharging overcurrent that has passed through the load 20 is flowing. In such a case, the flow of a discharging overcurrent that has passed through the load 20 can be prevented by switching the first cut-off unit 41 to the first cut-off state.

### OTHER EMBODIMENTS

The present disclosure is not limited to the embodiments described above and illustrated in the drawings. For example, features of the above or following embodiments can be combined in any manner as long as no contradiction arises. Furthermore, any feature of the above or following embodiments may be omitted unless explicitly stated as essential. Furthermore, the above embodiments may be modified as follows.

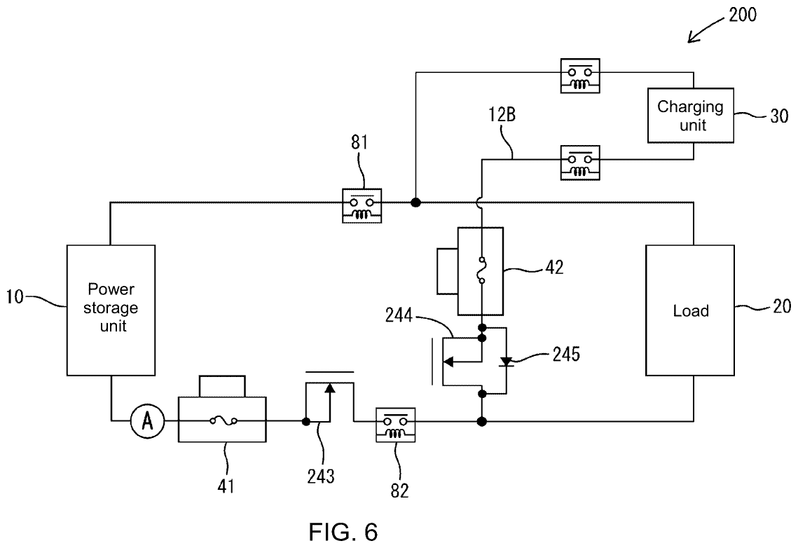

In the configuration of the second embodiment shown in FIG. 3, in the second branch path 12B, the positions of the second cut-off unit 42 and the second semiconductor circuit breaker 244 may be swapped as shown in FIG. 6. Note that in FIGS. 6 to 10, the control unit 50, the drive circuits (such as the first drive circuit 61), and the like are not shown, but they have the same configurations as those in FIGS. 4 and 5.

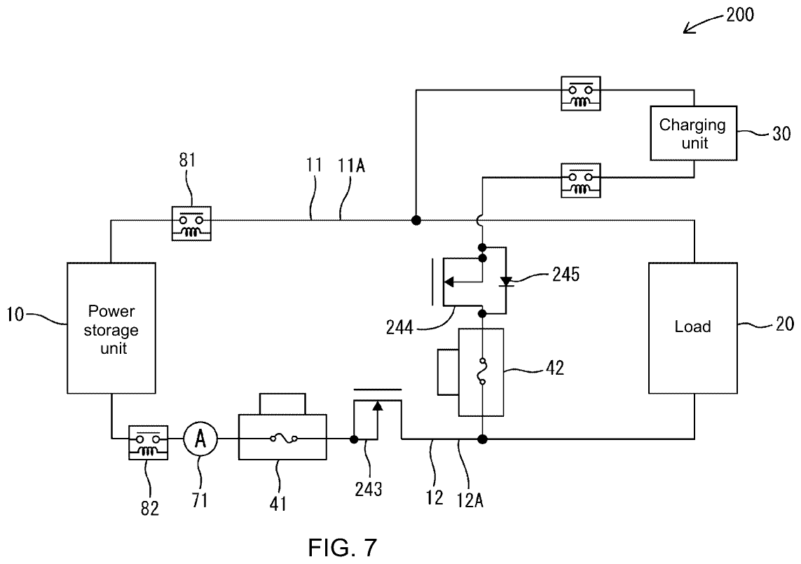

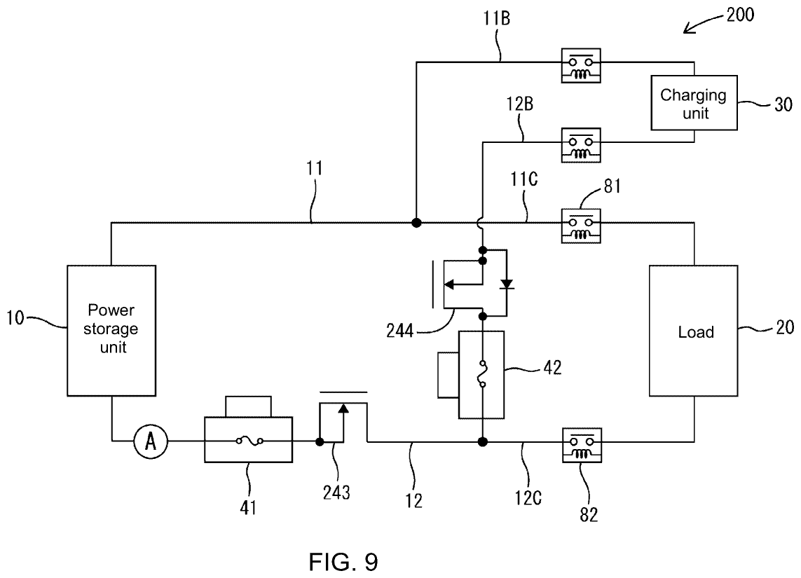

In the configuration of the second embodiment shown in FIG. 3, the positions of the switches 81 and 82 may be changed to positions closer to the power storage unit 10 as shown in FIG. 7. The switch 82 is provided between the power storage unit 10 and the first cut-off unit 41 in the second common path 12A. Moreover, as shown in FIG. 9, the positions of the switches 81 and 82 may be changed to positions closer to the load 20. The switch 81 is provided between the first branch path 11B and the load 20. The switch 82 is provided between the second branch path 12B and the load 20.

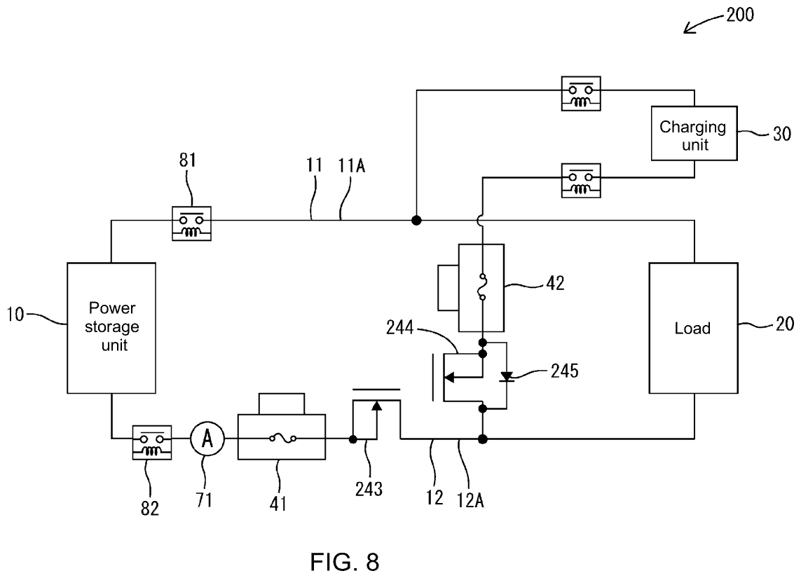

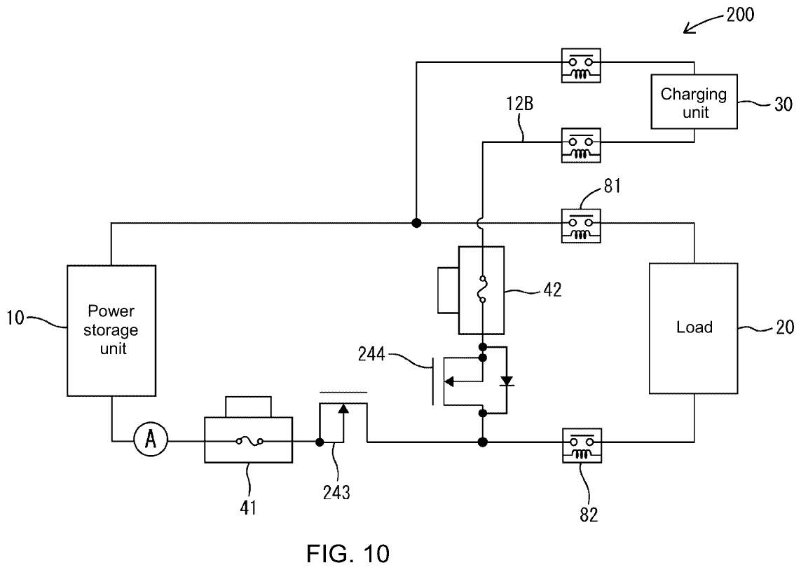

As shown in FIGS. 8 and 10, the positional relationship between the second cut-off unit 42 and the second semiconductor circuit breaker 244 may be as shown in FIG. 6, and the positional relationship between the switches 81 and 82 may be similar to that in FIGS. 7 and 10.

The first cut-off unit 41 is provided in the second common path 12A in the first and second embodiments, but may be provided in only the first common path 11A, or in both the first common path 11A and the second common path 12A. Similarly, the second cut-off unit 42 is provided in the second branch path 12B, but may be provided in only the first branch path 11B, or in both the first branch path 11B and the second branch path 12B.

The first detection unit 71 is provided in the second common path 12A in the first and second embodiments, but may be provided in only the first common path 11A, or in both the first common path 11A and the second common path 12A. The second detection unit 72 is provided in the second branch path 12B, but may be provided in only the first branch path 11B, or in both the first branch path 11B and the second branch path 12B, as long as it can detect that a current is flowing in the first branch path 11B.

The first semiconductor circuit breaker 243 is provided in the second common path 12A in the second embodiment, but may be provided in only the first common path 11A, or in both the first common path 11A and the second common path 12A.

In the first embodiment, in step S18 in FIG. 2, the first cut-off unit 41 is caused to perform the cut-off operation, but the second cut-off unit 42 may also be caused to perform the cut-off operation. In the second embodiment described above, in step S25 of FIG. 5, the first semiconductor circuit breaker 243 and the first cut-off unit 41 are caused to perform the cut-off operation, but the second cut-off unit 42 may also be caused to perform the cut-off operation.

In the second embodiment, the first semiconductor circuit breaker 243 and the second semiconductor circuit breaker 244 are n-channel MOSFETs, but they may be other semiconductor switches such as an insulated gate bipolar transistor (IGBT).

The control unit 50 in the first embodiment may have an internal configuration similar to the internal configuration of the control unit 50 illustrated in the second embodiment.

It should be noted that the embodiments disclosed herein are illustrative in all respects and are not intended to be restrictive. The scope of the present disclosure is not limited to the embodiments disclosed herein, but rather is intended to include all modifications within the scope indicated by the claims or the scope equivalent to the claims.

1. A vehicle cut-off control device to be used in a vehicle power supply system including a power storage unit configured to be charged by a charging unit and a load configured to receive a supply of electric power from the power storage unit,
the vehicle power supply system further including
a first conductive path provided between a high potential terminal of the power storage unit and a high potential terminal of the load,
a second conductive path provided between a low potential terminal of the power storage unit and a low potential terminal of the load,
a first branch path branching off from the first conductive path and provided between the first conductive path and a high potential terminal of the charging unit, and
a second branch path branching off from the second conductive path and provided between the second conductive path and a low potential terminal of the charging unit,
the first conductive path having a first common path provided between the power storage unit and the first branch path, and a third branch path provided between the first branch path and the load, and
the second conductive path having a second common path provided between the power storage unit and the second branch path, and a fourth branch path provided between the second branch path and the load, and
the vehicle cut-off control device comprising:
a first cut-off unit configured to switch to a first cut-off state, in which at least one of the first common path and the second common path is cut-off, from a first cancel state in which the first cut-off state is canceled;
a second cut-off unit configured to switch to a second cut-off state, in which at least one of the first branch path and the second branch path is cut-off, from a second cancel state in which the second cut-off state is canceled;
a first detection unit configured to detect a current value of a current flowing in at least one of the first common path and the second common path, and a direction in which the current is flowing;
a second detection unit configured to detect that a current is flowing in at least one of the first branch path and the second branch path; and
a control unit configured to switch the first cut-off unit from the first cancel state to the first cut-off state and switch the second cut-off unit from the second cancel state to the second cut-off state, based on detection signals detected by the first detection unit and the second detection unit.

2. The vehicle cut-off control device according to claim 1,
wherein with a first direction being a direction of a flow of a charging current from the high potential terminal of the charging unit toward the low potential terminal in at least one of the first common path and the second common path,
in a case where the current value detected by the first detection unit is in an increased state and the direction detected by the first detection unit is the first direction, the control unit sets the first cut-off unit to the first cancel state and sets the second cut-off unit to the second cut-off state.

3. The vehicle cut-off control device according to claim 1,
wherein with a second direction being a direction of a flow of a charging current from the low potential terminal of the charging unit toward the high potential terminal in at least one of the first common path and the second common path,
in a case where the current value detected by the first detection unit is in an increased state, furthermore the direction detected by the first detection unit is the second direction, and furthermore the second detection unit detected that a current is flowing in at least one of the first branch path and the second branch path, the control unit sets the first cut-off unit to the first cancel state and sets the second cut-off unit to the second cut-off state.

4. The vehicle cut-off control device according to claim 1,
wherein with a second direction being a direction of a flow of a charging current from the low potential terminal of the charging unit toward the high potential terminal in at least one of the first common path and the second common path,
in a case where the current value detected by the first detection unit is in an increased state, furthermore the direction detected by the first detection unit is the second direction, and furthermore the second detection unit detected that a current is not flowing in at least one of the first branch path and the second branch path, the control unit sets the first cut-off unit to the first cut-off state.

5. The vehicle cut-off control device according to claim 1, wherein the first detection unit is provided in one of the first common path and the second common path, and is a current sensor that detects a current value and a direction of a current in the one common path.

6. The vehicle cut-off control device according to claim 1, wherein the second detection unit is provided in one of the first branch path and the second branch path, or in one of the third branch path and the fourth branch path, and is a current sensor that detects that a current is flowing in at least one of the first branch path and the second branch path based on a current flowing in at least one of the first branch path and the second branch path or in at least one of the third branch path and the fourth branch path.

7. The vehicle cut-off control device according to claim 1, further including:
a semiconductor circuit breaker configured to, under control of the control unit, switch between a third cut-off state, in which at least one of the first branch path and the second branch path is cut-off, and a third cancel state in which the third cut-off state is canceled; and
a diode connected in parallel with the semiconductor circuit breaker such that an anode is provided on a low potential terminal side of the charging unit and a cathode is provided on a high potential terminal side of the charging unit,
wherein the second detection unit detects a voltage of the anode relative to the cathode, and
when the semiconductor circuit breaker is set to the third cut-off state, in a case where the voltage detected by the second detection unit is in a first high voltage state, the control unit determines that a current is flowing in at least one of the first branch path and the second branch path.

8. The vehicle cut-off control device according to claim 1, further including:
a semiconductor circuit breaker configured to, under control of the control unit, switch between a third cut-off state, in which at least one of the first branch path and the second branch path is cut-off, and a third cancel state in which the third cut-off state is canceled; and
a diode connected in parallel with the semiconductor circuit breaker such that an anode is provided on a low potential terminal side of the charging unit and a cathode is provided on a high potential terminal side of the charging unit,
wherein the second detection unit detects a voltage of the cathode relative to the anode, and
when the semiconductor circuit breaker is set to the third cut-off state, in a case where the voltage detected by the second detection unit is in a second high voltage state, the control unit determines that a current is not flowing in at least one of the first branch path and the second branch path, and switches the first cut-off unit from the first cancel state to the first cut-off state.

9. The vehicle cut-off control device according to claim 2,
wherein with a second direction being a direction of a flow of a charging current from the low potential terminal of the charging unit toward the high potential terminal in at least one of the first common path and the second common path,
in a case where the current value detected by the first detection unit is in an increased state, furthermore the direction detected by the first detection unit is the second direction, and furthermore the second detection unit detected that a current is flowing in at least one of the first branch path and the second branch path, the control unit sets the first cut-off unit to the first cancel state and sets the second cut-off unit to the second cut-off state.

10. The vehicle cut-off control device according to claim 2,
wherein with a second direction being a direction of a flow of a charging current from the low potential terminal of the charging unit toward the high potential terminal in at least one of the first common path and the second common path,
in a case where the current value detected by the first detection unit is in an increased state, furthermore the direction detected by the first detection unit is the second direction, and furthermore the second detection unit detected that a current is not flowing in at least one of the first branch path and the second branch path, the control unit sets the first cut-off unit to the first cut-off state.

11. The vehicle cut-off control device according to claim 2, wherein the first detection unit is provided in one of the first common path and the second common path, and is a current sensor that detects a current value and a direction of a current in the one common path.

12. The vehicle cut-off control device according to claim 2, wherein the second detection unit is provided in one of the first branch path and the second branch path, or in one of the third branch path and the fourth branch path, and is a current sensor that detects that a current is flowing in at least one of the first branch path and the second branch path based on a current flowing in at least one of the first branch path and the second branch path or in at least one of the third branch path and the fourth branch path.

13. The vehicle cut-off control device according to claim 2, further including:
a semiconductor circuit breaker configured to, under control of the control unit, switch between a third cut-off state, in which at least one of the first branch path and the second branch path is cut-off, and a third cancel state in which the third cut-off state is canceled; and
a diode connected in parallel with the semiconductor circuit breaker such that an anode is provided on a low potential terminal side of the charging unit and a cathode is provided on a high potential terminal side of the charging unit,
wherein the second detection unit detects a voltage of the anode relative to the cathode, and
when the semiconductor circuit breaker is set to the third cut-off state, in a case where the voltage detected by the second detection unit is in a first high voltage state, the control unit determines that a current is flowing in at least one of the first branch path and the second branch path.

14. The vehicle cut-off control device according to claim 2, further including:
a semiconductor circuit breaker configured to, under control of the control unit, switch between a third cut-off state, in which at least one of the first branch path and the second branch path is cut-off, and a third cancel state in which the third cut-off state is canceled; and
a diode connected in parallel with the semiconductor circuit breaker such that an anode is provided on a low potential terminal side of the charging unit and a cathode is provided on a high potential terminal side of the charging unit,
wherein the second detection unit detects a voltage of the cathode relative to the anode, and
when the semiconductor circuit breaker is set to the third cut-off state, in a case where the voltage detected by the second detection unit is in a second high voltage state, the control unit determines that a current is not flowing in at least one of the first branch path and the second branch path, and switches the first cut-off unit from the first cancel state to the first cut-off state.
